(19) United States
(12) Patent Application Publication
(10) Pub. No.: US 2007/0137057 A1
(43) Pub. Date: Jun. 21, 2007

(54) Stylus tip for workpiece contacting probe

(75) Inventor: Magdalena Lewicka-Schafer, Bristol (GB)

Correspondence Address: OLIFF & BERRIDGE, PLC, P.O. BOX 19928, ALEXANDRIA, VA, 22320, US

(73) Assignee: Renishaw PLC, Gloucestershire (GB)

(21) Appl. No.: 10/567,103

(22) PCT Filed: Aug. 6, 2004
(86) PCT No.: PCT/GB04/03402

§ 371 Date: Feb. 3, 2006

(30) Foreign Application Priority Data
Aug. 6, 2003 (GB) 0318388.6

(51) Int. Cl. G01B 5/00

(52) U.S. Cl. 33/559

(57) ABSTRACT

A stylus 12 for a workpiece contacting probe has a tip 14 which comprises a self-lubricating or low friction material, in order to inhibit debris generation or adhesive wear (pick up) as the tip scans a workpiece surface. Various materials are described, including composites having a solid state lubricant incorporated into a dimensionally stable microstructure. The tip 14 may be made entirely of such a composite, or may have a substrate 30 with a coating 32 of the self-lubricating or low friction material.

### BACKGROUND OF THE INVENTION

1. Field of the Invention

This invention relates to contact probes of the type used for measuring workpieces, and more particularly to tips for the styli of such probes.

By the term “contact probe” or “workpiece contacting probe”, we include not only probes for coordinate measuring machines, machine tools and the like, but also other metrological apparatus having a workpiece-contacting stylus, such as surface profilometers and roundness measuring machines, including those sold under the trade marks “Talysurf” and “Talyrond”.

2. Description of Prior Art

Known contact probes for measuring workpieces include a stylus with a workpiece contacting tip at its free end. The stylus tip may for example be spherical, and the accuracy of the spherical shape is important for the accuracy of measurements made with the probe.

U.S. Pat. No. 4,153,998 (McMurtry) shows a type of probe known as a touch trigger probe. This type of probe is simply brought into contact at discrete points on the workpiece surface, and issues a trigger signal when contact is established. An alternative type of probe incorporates transducers which measure deflection of the stylus relative to a body of the probe as a result of contact. See for example U.S. Pat. No. 4,084,323 (McMurtry). The latter type of probe, in particular, can be used for scanning the surface contours of the workpiece. During such scanning operations, the stylus tip is moved continuously in sliding contact with the workpiece surface.

The most common material used for stylus tips is synthetic ruby. Other materials sometimes used include silicon nitride (Si₃N₄) or zirconia (ZrO₂). U.S. Patent Application No. 2003/084584 (Osterstock) and the corresponding International Patent Application No. WO03/039233 (Q-Mark) disclose the use of silicon nitride. UK Patent Application No. GB 2243688 (De Beers) suggests the use of diamond or cubic boron nitride, although these materials are not used in practice.

### SUMMARY OF THE INVENTION

Research by the present applicants (leading to the present invention) shows that such scanning can result in three phenomena that may impact upon the metrological performance of the probe:
1. abrasive wear;
2. debris generation;
3. adhesive wear (also referred to as pick up).

Abrasive wear results in the form of the scanning stylus tip being altered as material is removed from it. This affects the accuracy of the sphericity of the stylus tip. The effect upon metrology is that data points taken in a particular orientation of the stylus indicate the position of the inspected surface as being further in (in the direction of probing) than it actually is. This results in workpieces appearing smaller than they actually are, or holes appearing larger than they actually are (an apparent “material off” condition).

Debris generation results in free or loosely adhered particles on the surface of the stylus tip or part under inspection. These particles can result in data points which indicate that an inspected surface is not as far in (in the direction of probing) as it actually is, but without this effect being associated with any particular orientation of the stylus. This results in workpieces appearing larger than they actually are, or holes appearing smaller than they actually are (an apparent “material on” condition).

Adhesive wear (pick up) occurs when material from a part being inspected adheres to the stylus tip. It is different from debris generation, in that the material is quite strongly adhered and the build up is localised in the region of the contact area of the stylus. The effect upon metrology is that data points taken in a particular orientation of the stylus indicate the inspected surface is not as far in (in the direction of probing as) it actually is. Again this appears to be a “material on” condition.

Our tests have shown that the phenomena exhibited by scanning systems vary with many parameters, including the combination of material being inspected and the material of the stylus tip. For example, ruby has good characteristics as a stylus tip material when measuring steel, but exhibits adhesive wear when measuring aluminium. Zirconia as a stylus tip material shows reasonable resistance to pick up (adhesive wear) when measuring aluminium, but shows abrasive wear on cast iron.

In general, if harder materials are chosen for the stylus tip, in order to prevent abrasive wear, then they are more susceptible to adhesive wear (pick up) and vice versa if softer materials are chosen.

In broad outline, the present invention seeks to provide alternative materials for stylus tips.

More particularly, the present invention provides a stylus tip made from or containing a self-lubricating material.

The material may be a composite comprising a low friction material or solid state lubricant, incorporated into a dimensionally stable microstructure. The lubricant may be graphite or a graphite-like material such as hexagonal boron nitride.

Optionally, the stylus tip may comprise a substrate, coated with a coating of said self-lubricating or low friction material.

Further aspects of the invention include styli having tips as defined above and probes incorporating such styli.

### BRIEF DESCRIPTION OF THE DRAWINGS

Preferred examples of the invention will now be described with reference to the accompanying drawings, in which:

FIG. 1 illustrates a contact probe having a stylus scanning the surface of a workpiece;

FIG. 2 illustrates a modification of this probe for use as a test set-up; and

FIG. 3 is a partly sectional view of a stylus.

### DESCRIPTION OF PREFERRED EMBODIMENTS

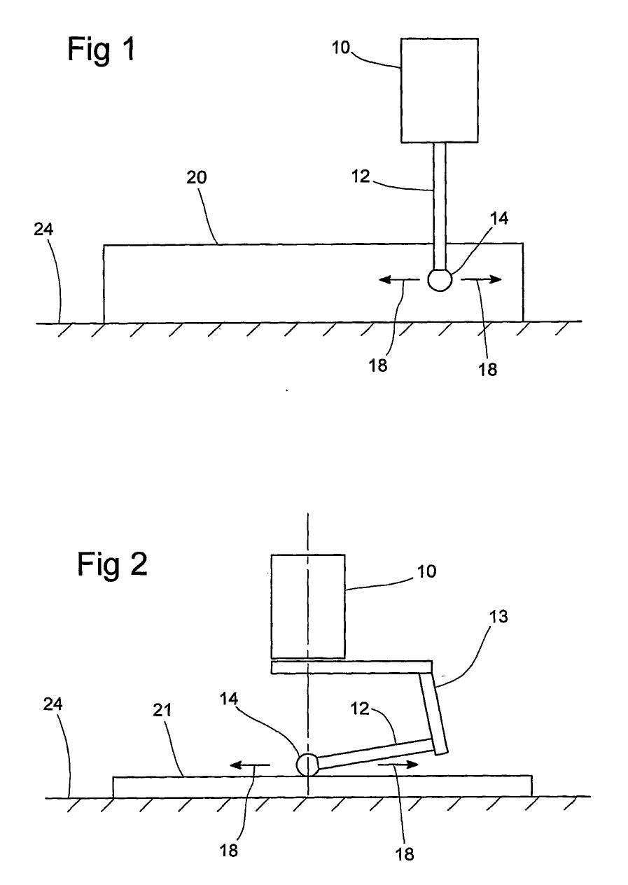

FIG. 1 shows a scanning probe having a body 10, stylus 12 and a spherical stylus tip 14. The probe body 10 contains transducers which measure deflection of the stylus 12 as the tip 14 scans the surface of a workpiece 20.

In normal use, the probe 10 would be mounted in a machine such as a coordinate measuring machine, digitising machine, scanning machine, machine tool, etc. The workpiece 20 is mounted on a bed or table 24 of the machine. The machine then moves the probe, relative to the workpiece, along a path so as to cause such scanning, as indicated by arrows 18.

Apart from the stylus tip 14, the probe is generally conventional, and so need not be described further. It may for example be the type SP600M sold by the present applicants, Renishaw plc. The stylus tip 14 is made from any of the materials discussed below.

FIG. 2 shows the probe 10 in a test set-up used to simulate normal use, in order to test various materials. An aluminium plate 21 was used as a test piece, mounted on the bed 24 of a Cyclone scanning machine (available from the present applicants, Renishaw plc).

The stylus 12 was mounted to the movable stylus holder of the probe 10 via an angled bracket 13, which held it so that in its neutral position the tip 14 was on the centre line of the probe, and so that the side of the tip 14 contacted the plate 21 during the test. This ensured that the roundness of the tip could be inspected after the test on a conventional Talyrond roundness measurement instrument (Taylor Hobson Limited, Leicester, UK) to check for wear, and the point at which the tip made scanning contact could be inspected under an optical microscope.

A stylus tip 14 of the material to be tested was mounted on the stylus 12 of the probe 10, which in turn was mounted in the movable part of the machine. The tip 14 was repeatedly scanned along the surface of the aluminium plate 21. Each continuous scan was for a distance of 500 mm along the aluminium plate 21 at a scanning speed of 100 mm/s and a scanning force of 25 g. Such 500 mm scans were repeated bi-directionally (as indicated by arrows 18). At the end of each 500 mm scan, the tip 14 was lifted from the surface of the plate 21 indexed laterally by at least 100 μm, and replaced for the next scan. This process was repeated until the desired total scanning distance had been achieved. The lateral indexing ensured that an undisturbed portion of the aluminium surface was scanned throughout the test.

The patch on the surface of the tip 14 which contacted the plate 21 during the scanning was examined under an optical microscope before the commencement of the test and after the desired total distance had been scanned.

### COMPARATIVE EXAMPLE 1

As a benchmark for comparison with the examples below of the present invention, a pure silicon carbide (SiC) 3 mm diameter ball was tested as the tip 14 in FIG. 2. Clearly visible pick up of aluminium was found on the surface of the SiC ball upon examination under the microscope after a scanning distance of 700 m.

### COMPARATIVE EXAMPLE 2

Using a conventional 3 mm diameter ruby stylus ball under the same scanning conditions, similar pick up of aluminium was seen on the surface of the ruby after a scanning distance of 700 m.

### EXAMPLE 1

To examine the effect of graphite acting as a solid state lubricant, the commercially available material Purebide PGS100 was used. This material is a sintered silicon carbide composite containing free graphite, available commercially from Morgan Advanced Materials and Technology, 441 Hall Avenue, St Marys, Pa. 15857, USA. It is stated by the manufacturers to be covered by U.S. Pat. Nos. 5,422,322, 5,656,563, 5,976,429 and European Patent No. 746532. Shapes close to spherical (3 mm diameter) were ground, polished and attached to standard stylus stems. In one test, no pick up of aluminium was apparent on the surface of the PGS100 material after scanning for 700 m. In a further test, the stylus tip was examined periodically without removing it from its holding bracket, which enabled the test to be continued after each examination. Up to 7000 m of scanning distance no obvious pick up was detected. Above 7000 m there was some directional pattern in the contact area, but nevertheless no clear signs of pick up were seen.

### EXAMPLE 2

Hexagonal boron nitride (hBN) is a naturally lubricious material having a graphite-like crystalline structure. It is often called white graphite. Thus, another example of the invention comprises a stylus tip made from a composite material containing hBN. A suitable material is described in “Fabrication and Microstructure of Silicon Nitride/Boron Nitride Nanocomposites”, T Kusunose, T Sekino, Y H Choa and K Niihara, Journal of the American Ceramic Society, 85, [11] 2678-88 (2002). This is a nanocomposite in which nano-sized particles of hBN are dispersed homogeneously in a matrix of silicon nitride (Si₃N₄). The material has good machinability, making it easier to fabricate accurately spherical balls for stylus tips than the PGS100 material of Example 1. The fine nanostructure also contributes to this.

We have found that it is desirable to select a suitable ratio of boron nitride to silicon nitride when using such materials. A sample containing 20% boron nitride was found to be softer than is desirable, and so was subject to wear when tested as shown in FIG. 2. Thus, we prefer to use a ratio of less than 20%, e.g. 5%-15% boron nitride.

### EXAMPLE 3

In place of the self-lubricating materials of Examples 1 and 2, a stylus tip may be made from a hard, porous matrix material, impregnated with a low friction material. The material of the porous matrix can be, for example, silicon carbide (SiC), silicon nitride (Si₃N₄) or zirconia (ZrO₂). The low friction material impregnated into it can be polytetrafluoroethylene (PTFE).

### EXAMPLE 4

The self-lubricating materials mentioned in Examples 1 and 2 can be replaced by other graphite-like materials (i.e. having lubricating properties derived from a similar crystalline structure).

Other self-lubricating materials which may be used include molybdenum sulphide and metallic tin.

Another material which can be used is boron carbide (B₄C) annealed to produce a self-replenishing solid lubricant film on its surface. This is described in a paper “Self-Replenishing Solid Lubricant Films On Boron Carbide” by A. Erdemir, O. K. Eryilmaz and G. R. Fenske, Surface Engineering, vol. 15, no. 4, 291-295.

### Example 5

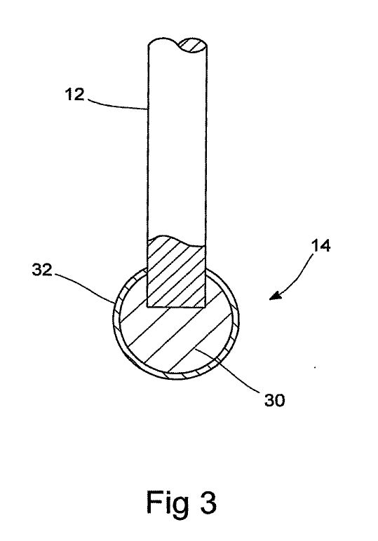

FIG. 3 shows a spherical stylus tip 14 attached to a stylus stem 12. As shown, the stem 12 is bonded into a hole drilled in the stylus tip 14, but this is not essential and other conventional methods of attachment may be used, such as bonding the spherical tip directly to the end of the stem, e.g. in a cup formed at the end of the stem.

The tip 14 in FIG. 3 differs from those discussed above, in that it comprises a spherical substrate 30, over which is provided a coating 32 of a self-lubricating or low friction material.

The substrate 32 is preferably a hard ceramic material. It may be chosen for a high Young's modulus, and for a low density (so that the resulting stylus tip is not too heavy, which could affect its metrological performance when scanning a workpiece surface). Suitable materials are zirconia (ZrO₂), alumina (Al₂O₃) and silicon nitride (Si₃N₄). Ruby would be possible, except that it is difficult to coat.

The coating 32 may be any of the self-lubricating or low friction materials discussed above.

Compared to conventional materials, stylus tips fabricated from self-lubricating materials or low friction materials such as those exemplified above are more resistant to aluminium pick up. They are also hard matrix composites with little susceptibility to abrasive wear. Resistance to abrasive wear is further increased through self-lubrication or low friction.

Furthermore, the lower friction to be expected from any of these materials during scanning operations is also advantageous, since low friction between the stylus tip and workpiece can improve the metrological performance of scanning probes. This arises because it reduces metrological errors due to the difference between the direction of the true normal to the surface (assumed by scanning software packages) and the probe deflection vector (i.e. the actual direction of deflection of the probe stylus tip under the action of contact forces with the workpiece surface). The probe deflection vector can differ from the true normal by up to the friction angle.

The examples have shown spherical stylus tips. However, the invention is equally applicable to stylus tips having other shapes, e.g. conical or cylindrical.

1. A stylus tip for a workpiece contacting probe, comprising a self-lubricating or low friction material.

2. A stylus tip according to claim 1, wherein the material is a composite comprising a low friction material or solid state lubricant, incorporated into a dimensionally stable microstructure.

3. A stylus tip according to claim 2, wherein the solid state lubricant is graphite or a graphite-like material.

4. A stylus tip according to claim 3, wherein the solid state lubricant is hexagonal boron nitride.

5. A stylus tip according to claim 4, wherein the dimensionally stable microstructure comprises silicon nitride.

6. A stylus tip according to claim 5, wherein the ratio of boron nitride to silicon nitride is less than 20%, preferably 5%-15%.

7. A stylus tip according to claim 1, comprising polytetrafluoroethylene impregnated in a matrix material.

8. A stylus tip according to claim 1, comprising boron carbide annealed to produce a solid lubricant film on its surface.

9. A stylus tip according to claim 1, wherein the self-lubricating material or film is self-replenishing.

10. A stylus tip according to claim 1, comprising a substrate and a coating over said substrate, the coating comprising said self-lubricating or low friction material.

11. A stylus for a workpiece contacting probe having a stylus tip according to claim 1.

12. A workpiece contacting probe having a stylus according to claim 11.
